(19) United States
(12) Patent Application Publication
(10) Pub. No.: US 2026/0267577 A1
(43) Pub. Date: Sep. 10, 2026

(54) PRINTING SYSTEM, PRINTING DEVICE, RESTORATION METHOD, AND NON-TRANSITORY COMPUTER-READABLE STORAGE MEDIUM STORING PROGRAM

(71) Applicant: SEIKO EPSON CORPORATION, Tokyo (JP)

(72) Inventors: Masamitsu SAKAMOTO, AZUMINO-SHI (JP); Toshiaki KOIKE, SHIOJIRI-SHI (JP)

(21) Appl. No.: 19/554,944

(22) Filed: Mar. 3, 2026

(30) Foreign Application Priority Data
Mar. 7, 2025 (JP) 2025-036009

(51) Int. Cl. G06F 3/12

(52) U.S. Cl. CPC G06F 3/1234; G06F 3/121; G06F 3/1231; G06F 3/1288

(57) ABSTRACT

There is provided a printing system in which a printing device that performs printing and a storage device are communicably connected to each other, and the printing device includes: a storage unit; a setting unit that saves, in the storage unit, a recovery point indicating a setting to be restored for a plurality of setting items, and saves, in the storage device, restoration information for restoring the recovery point; an error detection unit that detects an error in the recovery point saved in the storage unit; and a restoration unit that restores the recovery point saved in the storage unit, based on the restoration information saved in the storage device, when an error in the recovery point is detected.

### PROGRAM

The present application is based on, and claims priority from JP Application Serial Number 2025-036009, filed Mar. 7, 2025, the disclosure of which is hereby incorporated by reference herein in its entirety.

### BACKGROUND

### Technical Field

The present disclosure relates to a printing system, a printing device, a restoration method, and a non-transitory computer-readable storage medium storing a program.

### Related Art

According to the related art, a printing device is known in which a recovery point indicating a setting to be restored for a plurality of setting items is set, and the original setting can be restored by using the recovery point even when the setting of a setting item is changed.

JP-A-2022-109531 discloses a printing device that includes a storage unit storing restoration setting information and restores the setting of a setting item, based on the restoration setting information stored in the storage unit, upon receiving a restoration instruction giving an instruction to restore the setting.

JP-A-2022-109531 is an example of the related art.

In the related art, there is a problem in that the original setting cannot be restored when an error occurs in the recovery point stored in the storage unit of the printing device.

### SUMMARY

According to an aspect of the present disclosure, there is provided a printing system in which a printing device that performs printing and a storage device are communicably connected to each other, and the printing device includes: a storage unit; a setting unit that saves, in the storage unit, a recovery point indicating a setting to be restored for a plurality of setting items, and saves, in the storage device, restoration information for restoring the recovery point; an error detection unit that detects an error in the recovery point saved in the storage unit; and a restoration unit that restores the recovery point saved in the storage unit, based on the restoration information saved in the storage device, when an error in the recovery point is detected.

According to another aspect of the present disclosure, a printing device includes: a storage unit; a setting unit that saves, in the storage unit, a recovery point indicating a setting to be restored for a plurality of setting items, and saves, in an external storage device, restoration information for restoring the recovery point; an error detection unit that detects an error in the recovery point saved in the storage unit; and a restoration unit that restores the recovery point saved in the storage unit, based on the restoration information saved in the external storage device, when an error in the recovery point is detected.

According to still another aspect of the present disclosure, a restoration method includes causing a computer to execute processing of: saving, in a storage unit, a recovery point indicating a setting to be restored for a plurality of setting items, and saving, in an external storage device, restoration information for restoring the recovery point; detecting an error in the recovery point saved in the storage unit; and restoring the recovery point saved in the storage unit, based on the restoration information saved in the external storage device, when an error in the recovery point is detected.

According to still another aspect of the present disclosure, a non-transitory computer-readable storage medium storing a program is provided, and the program causes a computer to execute processing of: saving, in a storage unit, a recovery point indicating a setting to be restored for a plurality of setting items, and saving, in an external storage device, restoration information for restoring the recovery point; detecting an error in the recovery point saved in the storage unit; and restoring the recovery point saved in the storage unit, based on the restoration information saved in the external storage device, when an error in the recovery point is detected.

### BRIEF DESCRIPTION OF THE DRAWINGS

FIG. 1 is a diagram showing an example of a printing system according to an embodiment.

FIG. 2 is a diagram showing an example of the functional configuration of the printing system according to the embodiment.

FIG. 3 is a diagram showing an operation example of the printing system according to the embodiment.

FIG. 4 is a diagram showing an operation example of the printing system according to the embodiment.

FIG. 5 illustrates a case according to the related-art.

FIG. 6 illustrates the case of the printing system according to the embodiment.

### DESCRIPTION OF EMBODIMENTS

Hereinafter, an embodiment according to the present disclosure will be described in detail with reference to the drawings. However, an unnecessarily detailed description may be omitted. For example, a detailed description of already well-known matters or a repeated description about substantially the same configuration may be omitted.

In the description of the present disclosure, general abbreviations are sometimes used for the description. LAN is an abbreviation of local area network. HDD is an abbreviation for hard disk drive. SSD is an abbreviation for solid-state drive. NV is an abbreviation of nonvolatile memory. RAM is an abbreviation for random-access memory. ID is an abbreviation for identifier. CRC is an abbreviation for cyclic redundancy check. MD5 is an abbreviation for message digest algorithm 5. CPU is an abbreviation for central processing unit. MPU is an abbreviation for micro-processing unit. SoC is an abbreviation for system-on-a-chip. DSP is an abbreviation for digital signal processor. NAS is an abbreviation for network-attached storage. LSI is an abbreviation for large-scale integration. ASIC is an abbreviation for application-specific integrated circuit. PLD is an abbreviation for programmable logic device. FPGA is an abbreviation for field-programmable gate array. USB is an abbreviation for universal serial bus.

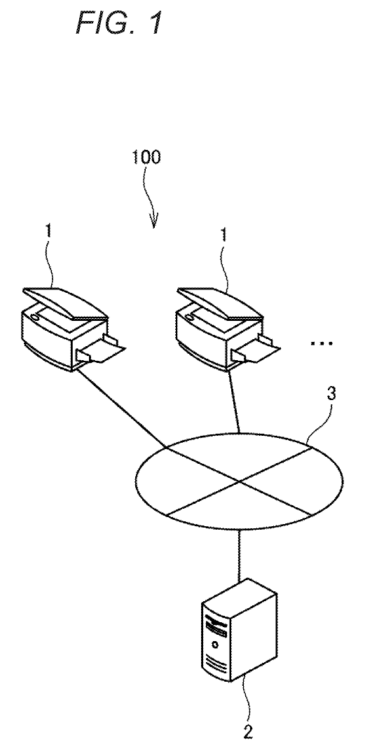

FIG. 1 is a diagram illustrating an example of a printing system according to an embodiment. As illustrated in FIG. 1, a printing system 100 includes a printer 1 and a storage device 2. The printer 1 and the storage device 2 are communicably connected to each other via a network 3. That is, the storage device 2 is a separate body from the printer 1 and is an external storage device for the printer 1. The network 3 is, for example, the internet, a LAN or the like. The printing system 100 may include one or a plurality of printers 1 and one or a plurality of storage devices 2.

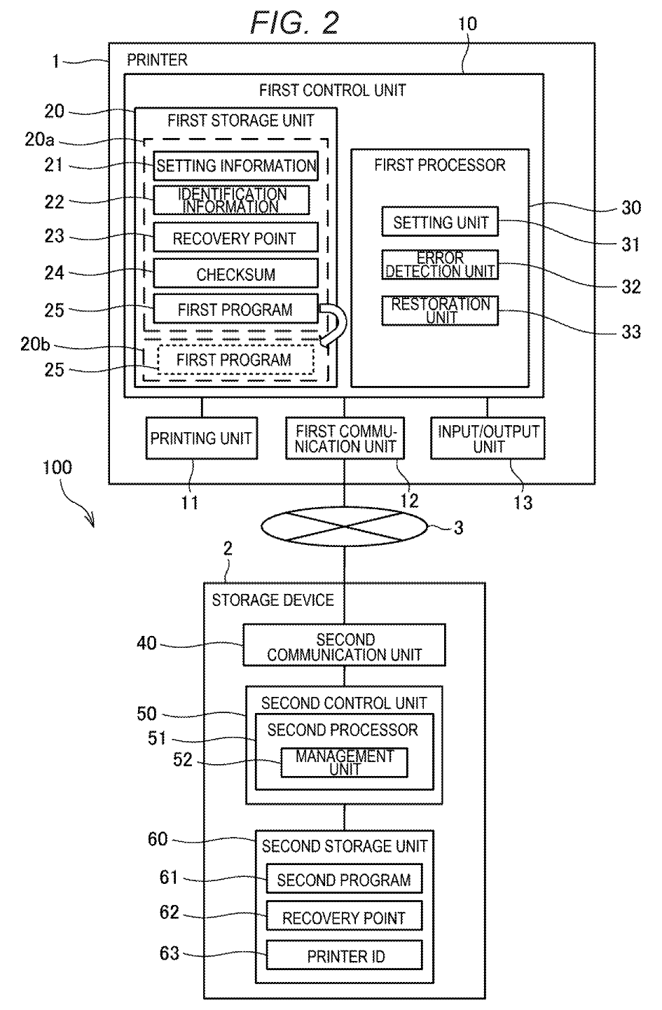

FIG. 2 is a diagram illustrating an example of the functional configuration of the printing system 100 according to the embodiment. As illustrated in FIG. 2, the printer 1 includes a first control unit 10, a printing unit 11, a first communication unit 12, and an input/output unit 13. The printer 1 is an example of a printing device.

The printing unit 11 is a processing unit that performs printing on a medium such as a paper under the control of the first control unit 10. The first communication unit 12 is a communication interface that communicates with an external device under the control of the first control unit 10. For example, the first communication unit 12 performs data communication with the storage device 2 via the network 3 under the control of the first control unit 10. The input/output unit 13 is an operation device such as a touch panel or an operation button that accepts an operation input from a user, and is a display device that outputs various information to the user, or the like.

The first control unit 10 includes a first storage unit 20 and a first processor 30. The first storage unit 20 includes a nonvolatile memory 20a, such as an HDD or an SSD, that can maintain the stored content even without power supply, and a volatile memory 20b that can maintain the stored content only while the RAM or the like is energized. The nonvolatile memory 20a may be referred to as NV.

The first storage unit 20 stores setting information 21, identification information 22, a recovery point 23, a checksum 24, and a first program 25 in the nonvolatile memory 20a. The volatile memory 20b of the first storage unit 20 is used as a work area when the first processor 30 executes the first program 25.

The setting information 21 is information indicating a setting value for each of various setting items in the printer 1. The setting items included in the setting information 21 include, for example, print settings in the printing unit 11. The setting value of the setting item is appropriately changed by a user operation via the input/output unit 13 or the like.

The identification information 22 is information for identifying various devices such as the printer 1 and the storage device 2. For example, the identification information 22 includes a printer ID as identification information indicating the printer 1. The identification information 22 includes a storage device ID as identification information indicating the external storage device 2 that stores the recovery point 23 of the printer 1. The printer ID and the storage device ID included in the identification information 22 may be any information that can identify the printer 1 and the storage device 2 on the network 3. For example, the printer ID and the storage device ID are a serial number, a MAC address, an IP address or the like that is unique to the printer 1 and the storage device 2.

The recovery point 23 is information indicating a setting to be restored for a plurality of setting items included in the setting information 21. For example, the recovery point 23 is a setting value set for each setting item at a predetermined time. As an example, the recovery point 23 is a setting value of each setting item to which a time stamp of a predetermined time is added, a copy of the setting information 21 to which a time stamp is added, or the like. The printer 1 can restore the setting content of the setting information 21 to the state as of the predetermined time by using the recovery point 23.

The checksum 24 is information for verifying the identity of the recovery point 23 and detecting whether there is an error in the recovery point 23. That is, the checksum 24 is an example of error detection information. For example, the checksum 24 is the remainder in dividing the sum of a data string of the recovery point 23 regarded as a string of integer values, by a predetermined constant. In the printer 1, the checksum 24 is compared with a value found by performing the same calculation on the recovery point 23 as the calculation of the checksum 24, and whether there is an error in the recovery point 23 can thus be detected.

The checksum 24 may be any information that can detect whether there is an error in the recovery point 23, and is not limited to being found by calculating the sum of the data string regarded as a string of integer values. For example, the checksum 24 may be a CRC checksum, an MD5 checksum, or the like.

The first program 25 is program data that is sequentially executed by the first processor 30, which is an example of a computer, and thus causes the first processor 30 to implement the functions of a setting unit 31, an error detection unit 32, and a restoration unit 33.

The first processor 30 is an arithmetic processing device such as a CPU or an MPU. The first processor 30 can be configured with a single arithmetic processing device or may be configured with a plurality of arithmetic processing devices. The first processor 30 may be configured with an SoC integrated with a part or the entirety of the first storage unit 20 and other circuits. The first processor 30 may be configured with a combination of a CPU that executes the first program 25 and a DSP that executes predetermined arithmetic processing. Also, the first processor 30 may have a configuration in which all the functions thereof are implemented by hardware, or may be configured with a programmable device.

The first processor 30 reads the first program 25 from the first storage unit 20, sequentially executes the first program 25, and thus provides the functions of the setting unit 31, the error detection unit 32, and the restoration unit 33.

The setting unit 31 is a processing unit that configures various settings related to the printer 1, based on an operation input accepted from the user via the input/output unit 13. Specifically, the setting unit 31 accepts an input of a setting value from the user for each of a plurality of setting items, and updates the setting information 21 stored in the nonvolatile memory 20a with the accepted content.

Also, when the setting information 21 is updated, the setting unit 31 generates the recovery point 23 for returning the setting information 21 to the time point at which the setting information 21 is updated, and the checksum 24 of the recovery point 23. For example, the setting unit 31 generates the recovery point 23 by copying the updated setting information 21 and adding the current time thereto as a time stamp. The setting unit 31 generates the checksum 24 by performing the above-described calculation on the generated recovery point 23. Then, the setting unit 31 saves the generated recovery point 23 and checksum 24 in the nonvolatile memory 20a of the first storage unit 20.

Also, the setting unit 31 generates restoration information for restoring the recovery point 23, notifies the storage device 2 of the generated restoration information together with the printer ID included in the identification information 22, and thus causes the storage device 2 to save the restoration information with the printer ID. Specifically, the setting unit 31 copies the recovery point 23 as the restoration information for restoring the recovery point 23. Then, the setting unit 31 notifies the storage device 2 of a recovery point 62 that is the copy, together with a printer ID 63.

In the present embodiment, an example in which the recovery point 62, which is a copy of the recovery point 23, is used as the restoration information, is described, but the restoration information may be any information for restoring the recovery point 23. For example, the restoration information may be an error correction code such as a Hamming code. As an example, the restoration information may include an error correction code for detecting and correcting an error with respect to the setting value for each setting item included in the recovery point 23.

The error detection unit 32 is a processing unit that detects an error in the recovery point 23 saved in the nonvolatile memory 20a of the first storage unit 20. For example, the error detection unit 32 compares the checksum found from the recovery point 23 saved in the nonvolatile memory 20a with the checksum 24 saved in the nonvolatile memory 20a. When these checksums do not match in this comparison, the error detection unit 32 detects that there is an error in the recovery point 23.

The method of detecting the error in the recovery point 23 is not limited to the method using the checksum 24. For example, when a defective sector or the like is detected in the nonvolatile memory 20a, the error detection unit 32 may detect that there is an error in the recovery point 23.

The restoration unit 33 is a processing unit that restores the recovery point 23 to an original state of having no error, when the error detection unit 32 detects the error of the recovery point 23. Specifically, the restoration unit 33 acquires, from the storage device 2, the recovery point 62 as the restoration information for restoring the recovery point 23 in which the error is detected, and restores the recovery point 23.

For example, the restoration unit 33 refers to the storage device ID included in the identification information 22 and specifies the storage device 2 saving the recovery point 23 from among the plurality of storage devices 2 connected to the network 3. Then, the restoration unit 33 requests the recovery point 62 from the specified storage device 2 by communication via the first communication unit 12. At this point, the restoration unit 33 notifies the storage device 2 of the request including the printer ID indicating the printer 1 that is the requester. The storage device 2 reads the recovery point 62 saved in association with the printer ID 63 which is notified of, and transmits the recovery point 62 to the printer 1.

Then, the restoration unit 33 restores the recovery point 23, based on the acquired recovery point 62. More specifically, the restoration unit 33 replaces the recovery point 23 with the recovery point 62 acquired from the storage device 2.

At this time, the restoration unit 33 may restore the setting information 21, using the restored recovery point 23. When an error in the recovery point 23 is detected, the setting information 21 may also include an error. Thus, as the restoration of the setting information 21 is automated using the restored recovery point 23 when the restoration unit 33 restores the recovery point 23, the setting information 21 returns to the original state without the user's awareness and this improves usability. For example, when an error is included in both the recovery point 23 and the setting information 21 when the power of the printer 1 is turned on, the restoration of the setting information 21 together with the recovery point 23 improves usability.

When the restoration information saved in the storage device 2 is an error correction code, the restoration unit 33 restores the recovery point 23 by correcting an error included in the recovery point 23, using the error correction code acquired from the storage device 2.

The storage device 2 includes a second communication unit 40, a second control unit 50, and a second storage unit 60. The storage device 2 is a server device having functions as a file server that manages and provides files, but may be a simple storage device. For example, the storage device 2 may be a NAS communicably connected to an external device such as the printer 1 via the network 3.

The second communication unit 40 is a communication interface that communicates with an external device under the control of the second control unit 50. For example, the second communication unit 40 performs data communication with the printer 1 via the network 3 under the control of the second control unit 50.

The second control unit 50 includes a second processor 51. The second processor 51 is an arithmetic processing device such as a CPU or an MPU. The second processor 51 may be configured with a single arithmetic processing device or may be configured with a plurality of arithmetic processing devices. The second processor 51 may be configured with an SoC integrated with a part or the entirety of the second storage unit 60 and other circuits. The second processor 51 may be configured with a combination of a CPU that executes a second program 61 and a DSP that executes predetermined arithmetic processing. Also, the second processor 51 may have a configuration in which all the functions thereof are implemented by hardware, or may be configured with a programmable device.

The second control unit 50 reads the second program 61 from the second storage unit 60, sequentially executes the second program 61, and thus provides the function of a management unit 52.

The management unit 52 is a processing unit that manages the recovery point 23 and the printer ID 63 which are notified of by the printer 1. Specifically, the management unit 52 saves the recovery point 62 which is notified of together with the printer ID 63 from the printer 1, in the second storage unit 60 in association with the printer ID 63. When there is a request for the recovery point 62 together with the printer ID 63, the management unit 52 reads the recovery point 62 associated with the printer ID 63 from the second storage unit 60 and transmits the recovery point 62 to the printer 1 via the second communication unit 40.

The second storage unit 60 is a storage device such as an HDD or an SSD. The second storage unit 60 stores the second program 61, the recovery point 62, and the printer ID 63.

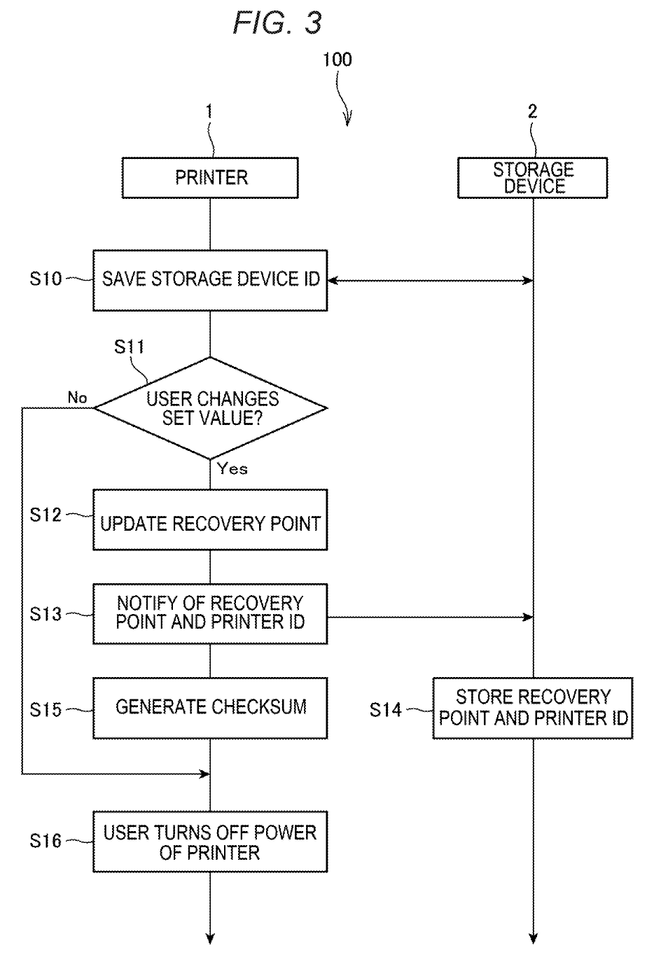

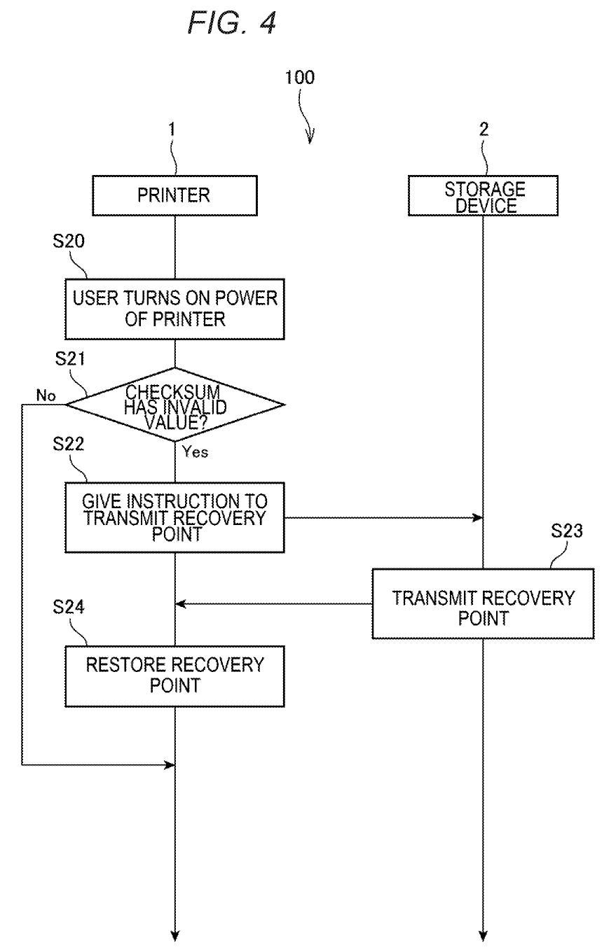

Next, an example of processing in the printing system 100 will be described with reference to FIGS. 3 and 4. FIGS. 3 and 4 are diagrams illustrating an operation example of the printing system 100 according to the embodiment. More specifically, FIG. 3 shows an operation example in a case where the recovery point 23 is updated due to a change in the setting information 21 of the printer 1. Also, FIG. 4 shows an operation example related to the restoration of the recovery point 23.

As illustrated in FIG. 3, the setting unit 31 of the printer 1 acquires the storage device ID for identifying the storage device 2 by communication with the storage device 2 via the first communication unit 12, and saves the storage device ID in the identification information 22 (S10).

Next, the setting unit 31 of the printer 1 determines whether the user changes the setting values of the plurality of setting items included in the setting information 21 (S11). When the user does not change the setting value (No in S11), the setting unit 31 advances the processing to S16.

When the user changes the setting value of any of the setting items (Yes in S11), the setting unit 31 generates the recovery point 23 to which the time stamp of the time of update is added, and updates the recovery point 23 in the nonvolatile memory 20a (S12).

Next, the setting unit 31 generates the recovery point 62, which is a copy of the recovery point 23, as the restoration information for restoring the updated recovery point 23. Next, the setting unit 31 notifies the storage device 2 of the generated recovery point 62 and the printer ID 63 included in the identification information 22 (S13). The management unit 52 of the storage device 2 stores the recovery point 62 which is notified of from the printer 1, in association with the printer ID 63 in the second storage unit 60 (S14).

Next, the setting unit 31 generates the checksum 24 by performing the above-described calculation based on the updated recovery point 23, and saves the generated checksum 24 in the nonvolatile memory 20a (S15).

Next, the power of the printer 1 is turned off by the user operating the power button in the input/output unit 13 (S16).

As shown in FIG. 4, the power of the printer 1 is turned on by the user operating the power button in the input/output unit 13 (S20).

When the power is turned on, the error detection unit 32 compares the checksum found from the recovery point 23 saved in the nonvolatile memory 20a with the checksum 24 saved in the nonvolatile memory 20a. In this comparison, the error detection unit 32 determines whether the checksum found from the recovery point 23 does not match the checksum 24 and the checksum found from the recovery point 23 has an invalid value (S21).

When there is no invalid value in the checksum found from the recovery point 23 (No in S21), there is no error in the recovery point 23 and therefore the restoration unit 33 skips the processing of S22 to S24.

When the checksum found from the recovery point 23 has an invalid value (Yes in S21), the restoration unit 33 determines that there is an error in the recovery point 23.

When there is an error in the recovery point 23, the restoration unit 33 refers to the storage device ID included in the identification information 22, and specifies the storage device 2 saving the recovery point 23 from among the plurality of storage devices 2 connected to the network 3. Next, the restoration unit 33 gives the specified storage device 2 an instruction to transmit the recovery point 62, after including the printer ID indicating the printer 1 that is the requester, in the instruction (S22).

The management unit 52 of the storage device 2 reads the recovery point 62 associated with the printer ID from the second storage unit 60, based on the instruction from the printer 1, and transmits the recovery point 62 to the printer 1 (S23).

The restoration unit 33 of the printer 1 replaces the recovery point 23 with the recovery point 62 acquired from the storage device 2 and thus restores the recovery point 23 in the original state of having no error (S24).

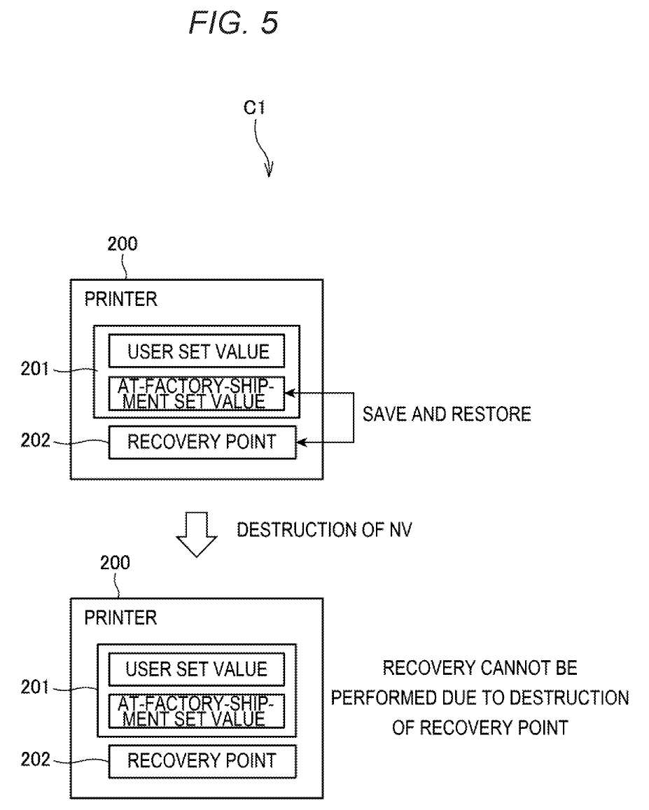

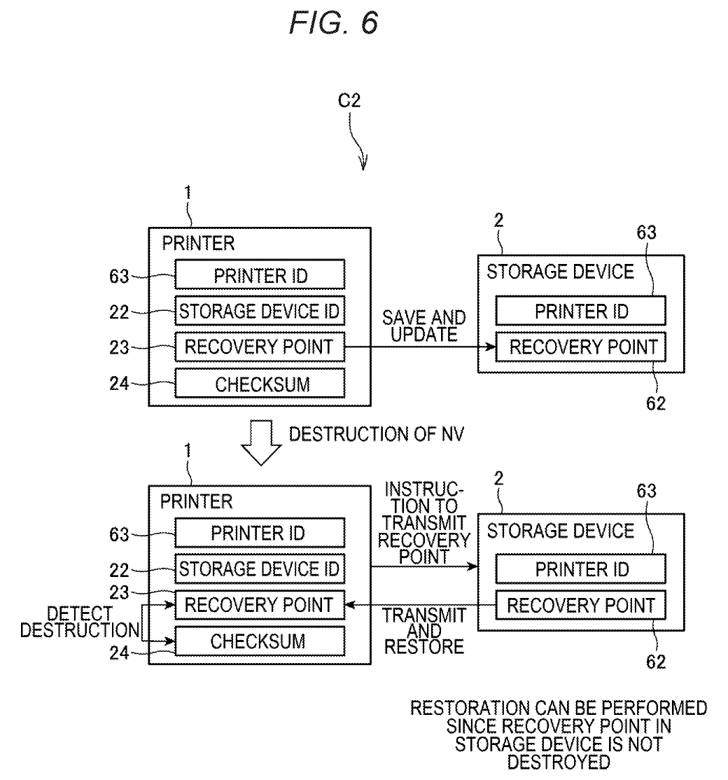

FIG. 5 is a diagram illustrating a case C1 according to the related art, and FIG. 6 is a diagram illustrating a case C2 of the printing system 100 according to the embodiment. As illustrated in FIG. 5, in the case C1 according to the related art, setting information 201 including a user set value, an at-factory-shipment set value, and the like, and a recovery point 202 related to the restoration of the setting information 201, are stored only in an NV of a printer 200.

Therefore, in the case C1, a sector defect or the like does not occur in the NV of the printer 200, and the setting information 201 can be restored, based on the recovery point 202, unless the data is destroyed.

However, in the case C1, when a sector defect or the like occurs in the NV of the printer 200 and the data is destroyed, the data of the recovery point 202 is destroyed as well and an error occurs in the recovery point 202. Therefore, in the case C1, the setting information 201 cannot be restored, based on the recovery point 202, and therefore the setting cannot be recovered.

Meanwhile, in the case C2 of the printing system 100 according to the embodiment, the recovery point 23, the checksum 24, and the identification information 22 including the storage device ID of the storage device saving the recovery point 23 are saved in the NV of the printer 1. Therefore, in the case C2, when a sector defect or the like occurs in the NV of the printer 1 and the data in the NV is destroyed, whether there is an error in the recovery point 23 can be verified, based on the checksum 24.

In the case C2, when the recovery point 23 is updated, the recovery point 62, which is a copy of the recovery point 23, is saved in the storage device 2 in association with the printer ID 63. The NV of the printer 1 and the storage device 2 are separate bodies. Therefore, even when a sector defect or the like occurs in the NV of the printer 1 and the data in the NV is destroyed, the saved content in the storage device 2 is not affected.

Therefore, in the case C2, when an error occurs in the recovery point 23, the recovery point 23 can be restored using the recovery point 62 saved in association with the printer ID 63 in the storage device 2 specified by the storage device ID.

As described above, the printing system 100 is a system in which the printer 1 that performs printing and the storage device 2 are communicably connected to each other. The printer 1 includes the first storage unit 20, the setting unit 31, the error detection unit 32, and the restoration unit 33. The setting unit 31 saves the recovery point 23 indicating the setting to be restored for a plurality of setting items, in the first storage unit 20. Also, the setting unit 31 saves the recovery point 62 as the restoration information for restoring the recovery point 23, in the storage device 2. The error detection unit 32 detects an error in the recovery point 23 saved in the first storage unit 20. When an error in the recovery point 23 is detected, the restoration unit 33 restores the recovery point 23 saved in the first storage unit 20, based on the recovery point 62 saved in the storage device 2.

Thus, in the printing system 100, even when data in the nonvolatile memory 20a is destroyed due to a sector defect or the like and an error occurs in the recovery point 23, the recovery point 23 can be restored, based on the recovery point 62 in the storage device 2. Therefore, in the printing system 100, the restoration of the setting information 21 using the recovery point 23 can be performed more reliably.

When the setting of at least one setting item of the plurality of setting items is changed, the setting unit 31 saves the recovery point 23 corresponding to the change of the setting in the first storage unit 20. Also, the setting unit 31 saves the recovery point 62 as the restoration information for restoring the recovery point 23, in the storage device 2.

Thus, in the printing system 100, the recovery point 23 for when the setting of at least one setting item of the plurality of setting items is changed can be restored.

Also, the setting unit 31 saves the checksum 24 as error detection information for detecting an error in the recovery point 23, in the first storage unit 20. The error detection unit 32 detects an error in the recovery point 23, based on the checksum 24 saved in the first storage unit 20.

Thus, in the printing system 100, an error in the recovery point 23 can be more reliably detected.

The error detection unit 32 detects an error in the recovery point 23 saved in the first storage unit 20 when the power of the printer 1 is turned on.

Thus, in the printing system 100, even when an error occurs in the recovery point 23 due to a memory defect, a sector defect, or the like caused by static electricity or the like while the power of the printer 1 is off, the recovery point 23 can be appropriately restored.

The setting unit 31 saves, in the first storage unit 20, the storage device ID for identifying the storage device 2 saving the restoration information, together with the recovery point 23. The restoration unit 33 acquires the restoration information from the storage device 2 corresponding to the storage device ID saved in the first storage unit 20, among a plurality of storage devices 2.

Thus, in the printing system 100, the recovery point 23 can be restored from the storage device 2 saving the restoration information, among the plurality of storage devices 2.

The setting unit 31 saves the printer ID 63 for identifying the printer 1 in the storage device 2 in association with the restoration information. The restoration unit 33 acquires the restoration information corresponding to the printer ID 63 from a plurality of pieces of restoration information saved in the storage device 2.

Thus, in the printing system 100, even when the restoration information of the plurality of printers 1 is saved in the storage device 2, the restoration information can be reliably acquired and the recovery point 23 can be restored.

The restoration information saved in the storage device 2 is a copy of the recovery point 23.

Thus, in the printing system 100, the recovery point 23 can be restored more reliably, based on the copy of the recovery point 23.

The above-described embodiment is a preferred embodiment of the present disclosure. However, the present disclosure is not limited to the embodiment, and various modified implementations can be made without departing from the spirit and scope of the present disclosure.

The functional units of the first control unit 10 and the second control unit 50 illustrated in FIG. 2 represent functional components implemented by the cooperation of hardware and software, and specific implementation forms of the functional units are not particularly limited. Therefore, hardware individually corresponding to each functional unit need not necessarily be installed. For example, as a matter of course, a configuration in which one first processor 30 may execute the first program 25 to implement the functions of a plurality of functional units may be employed. A part of the functions implemented by software in the above-described embodiment may be implemented by hardware, and a part of the functions implemented by hardware in the embodiment may be implemented by software.

For example, at least a part of the functional units of the first control unit 10 and the second control unit 50 illustrated in FIG. 2 may be configured with an integrated circuit or another digital circuit. At least a part of the functional units may include an analog circuit. The integrated circuit includes an LSI, an ASIC, and a PLD. The PLD includes, for example, an FPGA. Each of the functional units may be a combination of a processor and an integrated circuit. The combination is called, for example, MCU, SoC, system LSI, chip set, or the like.

The first program 25 executed by the first processor 30 to realize the above-described restoration method may be provided in the form of being recorded in a recording medium readable by the first processor 30. The recording medium readable by the first processor 30 may be an optical recording medium such as a DVD, a semiconductor memory device such as a USB memory or an SSD, or the like. The first program 25 may be provided in the form of a transmission medium that is stored on a computer connected to a network such as the internet and is downloaded via the network so as to be provided or distributed.

The processing elements in the flowchart shown in FIG. 3 or FIG. 4 are provided by dividing the processing according to the main content of the processing in order to facilitate the understanding of the processing of the first processor 30. The present disclosure is not limited by the way the processing is divided into the processing elements and the names of the processing elements illustrated in the flowchart of FIG. 3 or FIG. 4. Also, the processing of the first processor 30 may be divided into a larger number of processing elements according to the processing content, or may be divided such that one processing element includes a larger amount of processing. The processing order in the above flowcharts is not limited to the illustrated example, either.

Also, a configuration may be employed in which the printer 1 need not be identified and in which, for example, when the printer 1 and the storage device 2 are in a one-to-one relationship, the printer ID 63 is omitted. In this case, since the printer ID 63 is omitted, the number of elements can be reduced and a simple configuration can be employed.

### Summary of Present Disclosure

The present disclosure will be summarized below as Appendices.

### Appendix 1

There is provided a printing system in which a printing device that performs printing and a storage device are communicably connected to each other, and the printing device includes: a storage unit; a setting unit that saves, in the storage unit, a recovery point indicating a setting to be restored for a plurality of setting items, and saves, in the storage device, restoration information for restoring the recovery point; an error detection unit that detects an error in the recovery point saved in the storage unit; and a restoration unit that restores the recovery point saved in the storage unit, based on the restoration information saved in the storage device, when an error in the recovery point is detected.

Thus, even when an error occurs in the recovery point saved in the storage unit of the printing device, the recovery point can be restored and the setting can be more reliably restored using the recovery point.

### Appendix 2

In the printing system according to Appendix 1, when the setting of at least one setting item among the plurality of setting items is changed, the setting unit saves a recovery point corresponding to the change of the setting, in the storage unit, and saves restoration information for restoring the recovery point, in the storage device.

Thus, the recovery point for when the setting of at least one setting item of the plurality of setting items is changed can be restored.

### Appendix 3

In the printing system according to Appendix 1 or 2, the setting unit saves error detection information for detecting an error in the recovery point, in the storage unit, and the error detection unit detects an error in the recovery point, based on the error detection information saved in the storage unit.

Thus, an error in the recovery point can be reliably detected.

### Appendix 4

In the printing system according to any one of Appendices 1 to 3, the error detection unit detects an error in the recovery point saved in the storage unit, when a power of the printing device is turned on.

Thus, an error occurring in the recovery point while the power of the printing device is off can be detected and the recovery point can be restored.

### Appendix 5

In the printing system according to any one of Appendices 1 to 4, the setting unit saves, in the storage unit, first identification information for identifying the storage device saving the restoration information, together with the recovery point, and the restoration unit acquires the restoration information from a storage device corresponding to the first identification information saved in the storage unit, among the plurality of storage devices.

Thus, the recovery point can be restored from the storage device saving the restoration information, among the plurality of storage devices.

### Appendix 6

In the printing system according to any one of Appendices 1 to 5, the setting unit saves, in the storage device, second identification information for identifying the printing device in association with the restoration information, and the restoration unit acquires restoration information corresponding to the second identification information from a plurality of pieces of restoration information saved in the storage device.

Thus, even when the restoration information of a plurality of printing devices is saved in the storage device, the restoration information can be reliably acquired and the recovery point can be restored.

### Appendix 7

In the printing system according to any one of Appendices 1 to 6, the restoration information is a copy of the recovery point.

Thus, the recovery point can be restored more reliably, based on the copy of the recovery point.

### Appendix 8

A printing device includes: a storage unit; a setting unit that saves, in the storage unit, a recovery point indicating a setting to be restored for a plurality of setting items, and saves, in an external storage device, restoration information for restoring the recovery point; an error detection unit that detects an error in the recovery point saved in the storage unit; and a restoration unit that restores the recovery point saved in the storage unit, based on the restoration information saved in the external storage device, when an error in the recovery point is detected.

Thus, even when an error occurs in the recovery point saved in the storage unit of the printing device, the recovery point can be restored and the setting can be more reliably restored using the recovery point.

### Appendix 9

A restoration method includes causing a computer to execute processing of: saving, in a storage unit, a recovery point indicating a setting to be restored for a plurality of setting items, and saving, in an external storage device, restoration information for restoring the recovery point; detecting an error in the recovery point saved in the storage unit; and restoring the recovery point saved in the storage unit, based on the restoration information saved in the external storage device, when an error in the recovery point is detected.

Thus, even when an error occurs in the recovery point saved in the storage unit, the recovery point can be restored and the setting can be more reliably restored using the recovery point.

### Appendix 10

A non-transitory computer-readable storage medium storing a program is provided, and the program causes a computer to execute processing of: saving, in a storage unit, a recovery point indicating a setting to be restored for a plurality of setting items, and saving, in an external storage device, restoration information for restoring the recovery point; detecting an error in the recovery point saved in the storage unit; and restoring the recovery point saved in the storage unit, based on the restoration information saved in the external storage device, when an error in the recovery point is detected.

Thus, even when an error occurs in the recovery point saved in the storage unit, the recovery point can be restored and the setting can be more reliably restored using the recovery point.

What is claimed is:

1. A printing system in which a printing device that performs printing and a storage device are communicably connected to each other,
the printing device comprising:
a storage unit;
a setting unit configured to save, in the storage unit, a recovery point indicating a setting to be restored for a plurality of setting items, and save, in the storage device, restoration information for restoring the recovery point;
an error detection unit configured to detect an error in the recovery point saved in the storage unit; and
a restoration unit configured to restore the recovery point saved in the storage unit, based on the restoration information saved in the storage device, when an error in the recovery point is detected.

2. The printing system according to claim 1, wherein
when the setting of at least one setting item among the plurality of setting items is changed, the setting unit saves a recovery point corresponding to the change of the setting, in the storage unit, and saves restoration information for restoring the recovery point, in the storage device.

3. The printing system according to claim 1, wherein
the setting unit saves error detection information for detecting an error in the recovery point, in the storage unit, and
the error detection unit detects an error in the recovery point, based on the error detection information saved in the storage unit.

4. The printing system according to claim 1, wherein
the error detection unit detects an error in the recovery point saved in the storage unit, when a power of the printing device is turned on.

5. The printing system according to claim 1, wherein
the setting unit saves, in the storage unit, first identification information for identifying the storage device saving the restoration information, together with the recovery point, and
the restoration unit acquires the restoration information from a storage device corresponding to the first identification information saved in the storage unit, among the plurality of storage devices.

6. The printing system according to claim 1, wherein
the setting unit saves, in the storage device, second identification information for identifying the printing device in association with the restoration information, and
the restoration unit acquires restoration information corresponding to the second identification information from a plurality of pieces of restoration information saved in the storage device.

7. The printing system according to claim 1, wherein
the restoration information is a copy of the recovery point.

8. A printing device comprising:
a storage unit;
a setting unit configured to save, in the storage unit, a recovery point indicating a setting to be restored for a plurality of setting items, and save, in an external storage device, restoration information for restoring the recovery point;
an error detection unit configured to detect an error in the recovery point saved in the storage unit; and
a restoration unit configured to restore the recovery point saved in the storage unit, based on the restoration information saved in the external storage device, when an error in the recovery point is detected.

9. A restoration method comprising causing a computer to execute processing of:
saving, in a storage unit, a recovery point indicating a setting to be restored for a plurality of setting items, and saving, in an external storage device, restoration information for restoring the recovery point;
detecting an error in the recovery point saved in the storage unit; and
restoring the recovery point saved in the storage unit, based on the restoration information saved in the external storage device, when an error in the recovery point is detected.

10. A non-transitory computer-readable storage medium storing a program, the program causing a computer to execute processing of:
saving, in a storage unit, a recovery point indicating a setting to be restored for a plurality of setting items, and saving, in an external storage device, restoration information for restoring the recovery point;
detecting an error in the recovery point saved in the storage unit; and
restoring the recovery point saved in the storage unit, based on the restoration information saved in the external storage device, when an error in the recovery point is detected.
